(19) United States
(12) Patent Application Publication
(10) Pub. No.: US 2011/0260882 A1
(43) Pub. Date: Oct. 27, 2011

(54) METHOD AND APPARATUS FOR PROXIMITY SENSING OF A PORTABLE TERMINAL

(75) Inventors: Kwang Yeol Lee, Yongin-si (KR); Dong Won Han, Suwon-si (KR); Sang Ho Lee, Suwon-si (KR)

(73) Assignee: SAMSUNG ELECTRONICS CO. LTD., Suwon-si (KR)

(21) Appl. No.: 13/091,543

(22) Filed: Apr. 21, 2011

(30) Foreign Application Priority Data
Apr. 22, 2010 (KR) 10-2010-0037402

(51) Int. Cl. G08B 21/00

(52) U.S. Cl. 340/686.6

(57) ABSTRACT

A proximity sensing method of a portable terminal and a proximity sensing apparatus thereof are provided. The proximity sensing method of a portable terminal with an illumination sensor includes determining an output of the illumination sensor, determining that the portable terminal is proximate to an object when the output of the illumination sensor has a set pattern, and determining that the portable terminal is not proximate to the object when the output of the illumination sensor does not the set pattern. The proximity sensing method of a portable terminal may support a proximity sensing function using an illumination sensor instead of a proximity sensor to reduce a manufacturing cost of the portable terminal. In addition, since the method does not need a separate proximity sensor, it may address a lack of mounting space problem.

### PRIORITY

This application claims the benefit under 35 U.S.C. §119(a) of a Korean patent application filed on Apr. 22, 2010 in the Korean Intellectual Property Office and assigned Serial No. 10-2010-0037402, the entire disclosure of which is hereby incorporated by reference.

### BACKGROUND OF THE INVENTION

1. Field of the Invention

The present invention relates to a method and apparatus for a proximity sensing of a portable terminal. More particularly, the present invention relates to a method and apparatus capable of executing a proximity sensing function using an illumination sensor.

2. Description of the Related Art

Portable terminals have been used in a wide variety of fields due to their convenient use and easy portability. The portable terminal provides various functions such as a short message transmitting/receiving function, a photographing function, a music listening function, a digital broadcasting service function, an E-mail service function, and an Instant Messenger service function. In recent years, the number of portable terminals that are provided with an illumination sensor, which adjusts brightness of a display unit according to peripheral brightness, has increased. That is, when peripheral illumination is high, a portable terminal according to the related art increases brightness of a display unit to improve readability. The brightness of the display unit may be set to be relatively low at night when the peripheral illumination is low. Furthermore, the number of portable terminals supporting a proximity sensing function is increasing. To provide the proximity sensing function, the portable terminal according to the related art includes a separate proximity sensor. The proximity sensor is generally composed of a light emitting unit for emitting light and a receiving unit receiving reflected light. When the receiving unit senses light emitted from the emitting unit, the portable terminal according to the related art determines that the portable terminal is proximate to a certain object.

However, since the portable terminal must include a separate device such as a proximity sensor for proximity sensing or an illumination sensor for sensing illumination, there is a problem in that the manufacturing costs thereof are increased. Further, since a plurality of sensors (e.g., illumination sensor, proximity sensor, or the like) are mounted in the portable terminal according to the related art, there exists a problem of securing a mounting space. In addition, since the portable terminal according to the related art includes a plurality of sensors, power consumption occurs.

### SUMMARY OF THE INVENTION

Aspects of the present invention are to address at least the above-mentioned problems and/or disadvantages and to provide at least the advantages described below. Accordingly, an aspect of the present invention is to provide a proximity sensing method of a portable terminal capable of executing a proximity sensing function using an illumination sensor and a proximity sensing apparatus thereof.

In accordance with an aspect of the present invention, a proximity sensing method of a portable terminal including an illumination sensor is provided. The method includes determining an output of the illumination sensor, determining that the portable terminal is proximate to an object when the output of the illumination sensor has a preset pattern, and determining that the portable terminal is not proximate to the object when the output of the illumination sensor does not have the preset pattern.

In accordance with another aspect of the present invention, a proximity sensing apparatus of a portable terminal is provided. The apparatus includes a display unit for displaying an image corresponding to a preset frame frequency, an illumination sensor for outputting an electric signal corresponding to input light, and a controller for determining that the portable terminal is proximate to an object when the output of the illumination sensor has a preset pattern, and for determining that the portable terminal is not proximate to the object when the output of the illumination sensor does not have the preset pattern.

As described above, a proximity sensing method of a portable terminal and an apparatus thereof according to an exemplary embodiment of the present invention may support a proximity sensing function using an illumination sensor instead of a proximity sensor to reduce a manufacturing cost of the portable terminal. In addition, since the present invention does not need a separate proximity sensor, it may address a lack of mounting space problem.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram schematically illustrating a configuration of a portable terminal according to an exemplary embodiment of the present invention;

FIG. 2 is a graph illustrating output forms of an illumination sensor by situations according to an exemplary embodiment of the present invention;

FIG. 3 is a view illustrating a proximity sensing principle using an illumination sensor according to an exemplary embodiment of the present invention;

FIG. 4 is a flowchart schematically illustrating a proximity sensing method of a portable terminal according to an exemplary embodiment of the present invention; and

FIG. 5 is a flowchart schematically illustrating a proximity sensing method of a portable terminal in a call mode according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

A portable terminal, according to an exemplary embodiment of the present invention, is a terminal including a display unit and an illumination sensor, and may include a mobile communication terminal, a Personal Digital Assistant (PDA), a smart phone, and the like. Hereinafter, for convenience of a description, a mobile communication terminal is described by way of example.

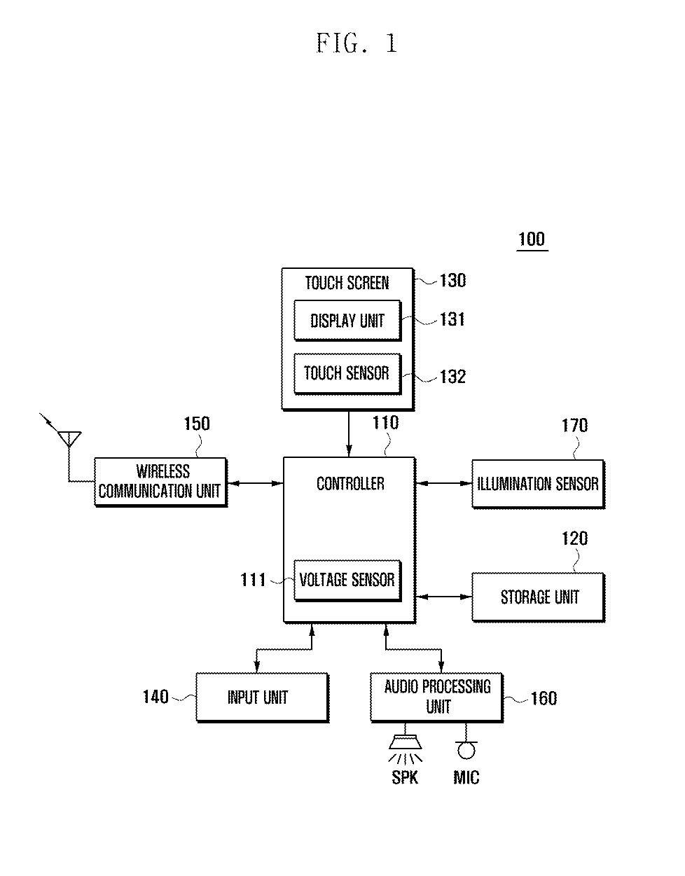

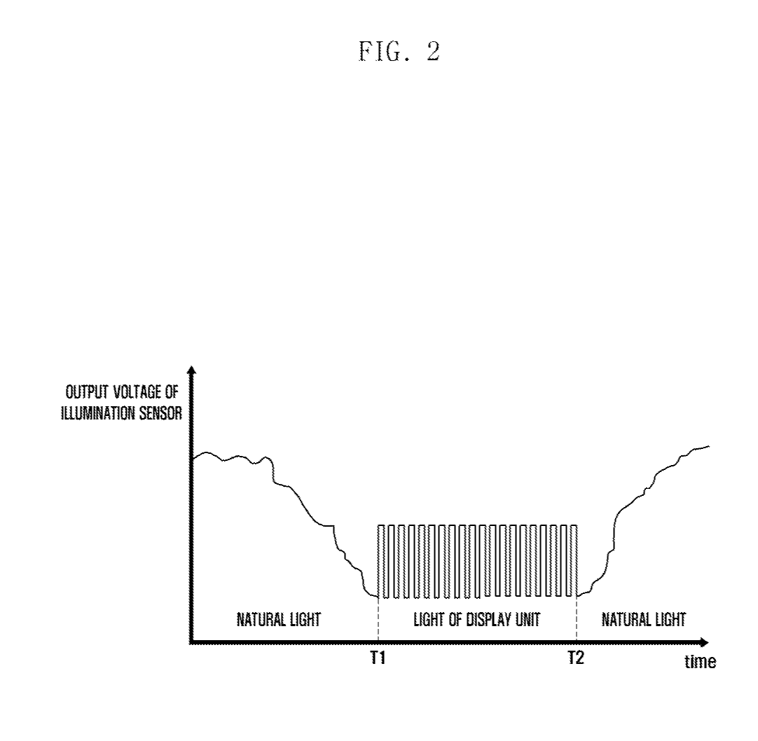

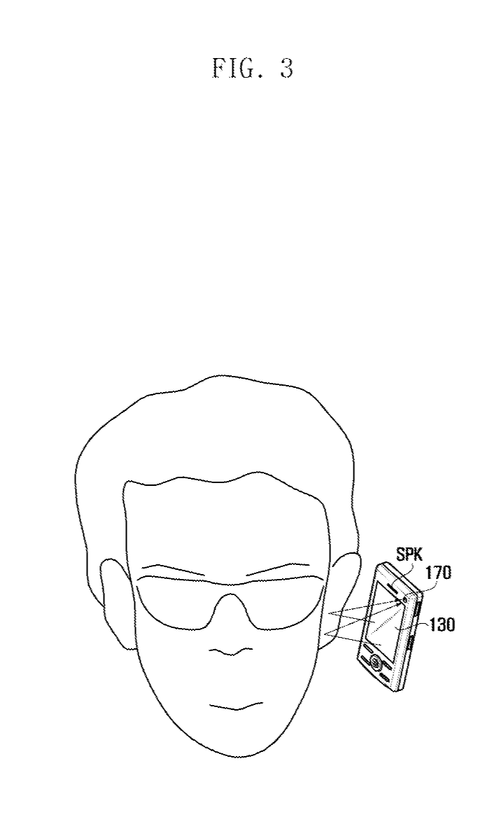

FIG. 1 is a block diagram schematically illustrating a configuration of a portable terminal according to an exemplary embodiment of the present invention. FIG. 2 is a graph illustrating output forms of an illumination sensor by situations according to an exemplary embodiment of the present invention. FIG. 3 is a view illustrating a proximity sensing principle using an illumination sensor according to an exemplary embodiment of the present invention.

Referring to FIG. 1 to FIG. 3, a portable terminal 100 may include an illumination sensor 170, an audio processing unit 160, a wireless communication unit 150, an input unit 140, a touch screen 130, a storage unit 120, and a controller 110. The touch screen 130 may include a display unit 131 and a touch sensor 132, and the controller 110 may include a voltage sensor 111.

The portable terminal 100 having such configuration analyzes an output pattern of the illumination sensor 170 to support execution of a proximity sensing function. In more detail, when the output pattern of the illumination sensor 170 has a preset certain frequency pattern, the controller 110 of the portable terminal 100 determines that the portable terminal 100 is proximate to an object (e.g., human body).

The audio processing unit 160 connects with a microphone (MIC) and a speaker (SPK). The audio processing unit 160 converts a speech signal input from the microphone into data and outputs the data to the controller 110. The audio processing unit 160 outputs a speech signal input from the controller 110 using the speaker. The audio processing unit 160 may play various audio signals (e.g., audio signal according to playback of an MP3 file) according to user selection.

The input unit 140 may receive input of various text information and transfer input signals associated with the setting of functions and function control of the portable terminal 100 to the controller 110. To do this, the input unit 140 may include a call key activating a call mode, a plurality of input keys for inputting texts or numerals, and an arrow key set to execute a specific function. The input unit 140 may include at least one of a key pad or a touch pad. The input unit 140 may be incorporated with the touch screen 130. That is, when the portable terminal 100 includes the touch screen 130, a configuration of the input unit 140 may be omitted.

The wireless communication unit 150 forms a first communication channel for a call and a second communication channel for transmitting data under the control of the controller 110. That is, the wireless communication unit 150 may form a speech call channel, a data communication channel, and a video call channel operatively associated with a base station. The wireless communication unit 150 may include a transmitter (not shown) for up-converting the frequency of a transmitted signal and for amplifying the signal, and a receiver (not shown) for low-noise-amplifying a received signal and for down-converting the signal.

The touch screen 130 is an input/output device executing both an input function and a display function. The touch screen 130 may include a display unit 131 and a touch sensor 132.

The display unit 131 displays information input by a user and information provided to the user as well as all types of menus of the portable terminal 100. For example, the display unit 131 may provide various screens such as an idle screen, a menu screen, a message creation screen, and a call screen according to use of the portable terminal 100. More particularly, the display unit 131 of the present invention may be automatically turned-on/off under the control of the controller 110. In more detail, when the portable terminal 100 is proximate to a human body, the controller 110 may turn-off the display unit 131. When the portable terminal 100 is not proximate to the human body, the controller 110 may turn-on the display unit 131. The display unit 131 may display an image corresponding to a frame frequency. For example, the display unit 131 may display the image in a progressive scanning scheme. That is, although a user cannot recognize, the display unit 131 does not always emit light but emits light corresponding to a frame frequency. When the display unit 131 has a frame rate of 30 and 400 vertical dot numbers, it may emit light with a frame frequency of 12,000 Hz. The foregoing display unit 131 may be configured by a Liquid Crystal Display (LCD), an Organic Light Emitted Diode (OLED), or an Active Matrix Organic Light Emitted Diode (AMOLED).

The touch sensor 132 may be positioned on the display unit 131. The touch sensor 132 may sense a touch occurring on a surface thereof. Here, the touch indicates a touch by a touch input device such as a stylus or by a human body part such as a finger or face of a user. When a finger of a user or a stylus touches on a surface of the touch sensor 132, it detects coordinates of the touch point and transmits the detected coordinates to the controller 110. More particularly, when a touch lock function is activated, although a touch occurs on a surface of the touch screen 130, the touch sensor 132 does not detect coordinates under the control of the controller 110. Further, the controller 110 may execute the touch lock function by disregarding coordinates transferred from the touch sensor 132.

The illumination sensor 170 is a sensor that may detect light. The illumination sensor 170 may output an electric signal (e.g., voltage signal) corresponding to input light. Here, an output (e.g., voltage) of the illumination sensor 170 is described as follows. As shown in FIG. 2, when natural light is incident on the illumination sensor 170, it outputs a continuous electric signal corresponding to an intensity of the incident light. When light emitted from the display unit 131 is incident to the illumination sensor 170, the illumination sensor 170 outputs a discrete signal that is turned-on/off with given time-periods. Namely, when light of the display unit 131 is incident to the illumination sensor 170, an output of the illumination sensor 170 does not have a continuous form but has a discrete form. This is why the display unit 131 does not always emit light but emits light according to a frame frequency as described previously. When the output of the illumination sensor 170 has a form as shown in FIG. 2, it is appreciated that the portable terminal 100 is proximate to an object at a time point T1, a proximity state maintains from the time point T1 to a time point T2, and the proximity state is canceled at the time point T2.

The illumination sensor 170 is preferably mounted at a position where peripheral light (natural light) is not incident and light of the display unit 131 may be incident in a state that a user performs a call after the user moves the portable terminal 100 near the user's face. For example, as shown in FIG. 3, the illumination sensor 170 may be located near a speaker. This is because the illumination sensor 170 may easily receive light of the display unit 131 reflected from a human body. Namely, when a user performs a call as shown in FIG. 3, because stronger light of a display unit 131 than natural light is input to the illumination sensor 170, an output of the illumination sensor 170 has a discrete form as shown in FIG. 2. The portable terminal 100 determines an output form of the illumination sensor 170 to determine proximity.

Meanwhile, the illumination sensor 170 may be used to determine a peripheral brightness degree, thereby automatically adjusting the brightness of the display unit 131. That is, the portable terminal 100 may increase the brightness of the display unit 131 in a bright exterior to improve readability. Similarly, the portable terminal 100 may reduce the brightness of the display unit in a dark exterior to reduce current consumption of a battery (not shown).

The storage unit 120 may store an Operating System (OS) of the portable terminal 100, application programs necessary for other option functions such as a sound playing function, an image or moving image playing function, or a broadcasting playing function, user data, and data transmitted and received at the communication time. In particular, the storage unit 120 may store set information for automatically controlling on/off of the display unit 131 using the illumination sensor 170 and touch lock/cancellation of the touch sensor 132. The set information may contain output voltage pattern information of the illumination sensor 170 output in a call state and information regarding setting or cancelling touch lock. Further, the storage unit 120 may store an application program for controlling on/off of the touch screen 130 using the illumination sensor 170. The storage unit 120 may be configured by a Read Only Memory (ROM), a Random Access Memory (RAM), and a Flash Memory.

The controller 110 controls an overall operation of the portable terminal 100 and signal flows between internal blocks of the portable terminal 100. The controller 110 may include a function of a data processor processing data. More particularly, when a proximity sensing mode is activated, the controller 110 determines an output form of the illumination sensor 170. In this case, when the output form of the illumination sensor 170 has a set specific pattern, the controller 110 may determine that the portable terminal 100 is proximate to an object (e.g., a face).

A user may activate the proximity sensing mode through a menu of the portable terminal 100. In an exemplary implementation, the proximity sensing mode may be switched automatically according to a mode of the portable terminal 100. For example, when a call mode is activated, the proximity sensing mode may be also activated. When the call mode is terminated, the proximity sensing mode may be inactivated. The set specific pattern may be a discrete frequency associated with a frame frequency for driving the display unit 131. To do this, the controller 110 may include a voltage sensor 111 for sensing a voltage level of an output signal of the illumination sensor 170.

When proximity is recognized in a call mode, the controller 110 may turn-off the display unit 131. When proximity is recognized in a call mode, the controller 110 may further execute a touch lock function. However, when the display unit 131 is turned-off, there arises a problem in which proximity cannot be recognized in a state that the portable terminal 100 is proximate to an object. To prevent the foregoing problem, the controller 110 does not turn-off the display unit 131 completely, and may control the illumination sensor to emit light with minimum brightness that the illumination sensor 170 may recognize. Further, the controller 110 may turn-off areas of the display unit 131 except for a partial area thereof. Since the illumination sensor 170 cannot receive light, the controller 110 cannot recognize proximity. To prevent such a problem, the controller 110 controls the display unit 131 to emit light in only a partial area thereof.

In an exemplary implementation, the partial area is set with a minimum area in consideration of the orientation of the portable terminal with respect to the user during a call and battery consumption. Furthermore, the partial area is may be located near the illumination sensor 170 such that the illumination sensor 170 may easily receive light. In another exemplary implementation, when the proximity is recognized, the controller 110 may completely turn-off the display unit 131 and maintain a proximity state until a light signal having a continuous pattern, namely natural light, is input.

When the proximity recognized in the call mode is canceled, the controller 110 may turn-on the display unit 131. Moreover, when the proximity is canceled, the controller 110 may cancel a touch lock function. Although not shown in FIG. 1, the portable terminal 100 may further include structural elements having additional functions such as a camera module for photographing images or moving images, a near distance communication module for near distance wireless communication, a broadcast receiving module for receiving broadcast, a digital sound source module like an MP3 module, and an Internet communication module executing Internet functions. Since the structural elements can be variously changed according to a convergence trend of a digital device, no elements are listed. However, the portable terminal 100 may include structural elements equivalent to the foregoing structural elements.

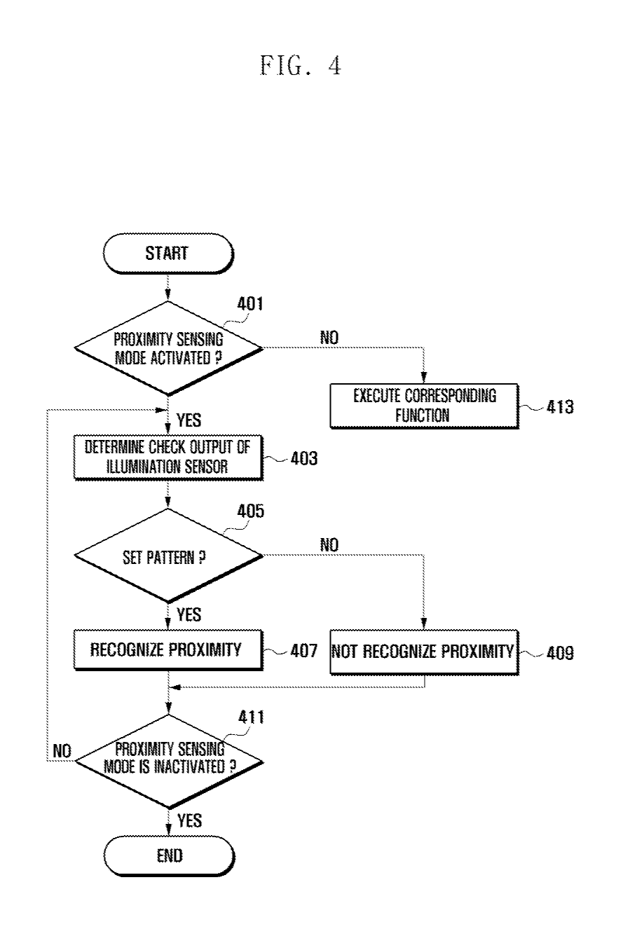

FIG. 4 is a flowchart schematically illustrating a proximity sensing method of a portable terminal according to an exemplary embodiment of the present invention

Referring to FIG. 1 and FIG. 4, a controller 110 may determine whether a proximity sensing mode is activated in step 401. In an exemplary implementation, a user may activate the proximity sensing mode through a menu of the portable terminal 100. Meanwhile, the proximity sensing mode may automatically switch on/off according to a mode of the portable terminal 100. For example, when a call mode is activated, the proximity sensing mode may also be activated. When the call mode is terminated, the proximity sensing mode may be inactivated. In the meantime, when the proximity sensing mode is set to be always on during driving of the portable terminal 100, step 401 may be omitted.

If it is determined in step 401 that the proximity sensing mode is inactivated, the controller 110 may execute a corresponding function in step 413. For example, the controller 110 may execute a music playing function, a photographing function, and the like. On the other hand, if it is determined in step 401 that the proximity sensing mode is activated, the controller 110 may determine an output of an illumination sensor 170 in step 403, and determine whether the output of the illumination sensor 170 has a set pattern in step 405. The output of the illumination sensor 170 may be a voltage corresponding to an intensity of light. To do this, the controller 110 may include a voltage sensor 111. The set pattern may be a discrete pattern associated with a frame frequency set to drive the display unit 131.

If it is determined in step 405 that the output of the illumination sensor 170 has the set pattern, the controller 110 may recognize proximity in step 407. In other words, the controller 110 may determine that the portable terminal 100 is proximate to an object (e.g., a face). Next, although not shown, the controller 110 may execute a function according to the proximity recognition. For example, the controller 100 may turn-off the display unit 131 or may execute a touch lock function. On the other hand, if it is determined in step 405 that the output of the illumination sensor 170 does not have the set pattern, the controller 110 cannot recognize the proximity in step 409. In other words, the controller 110 may determine that the portable terminal 100 is spaced apart from the object (e.g., face) by more than a certain distance. Subsequently, although not shown, the controller 110 may execute a function according to proximity cancellation. For example, the controller 110 may turn-on the display unit 131 in an off state or may cancel a touch lock state according to proximity recognition.

Next, the controller 110 may determine whether the proximity sensing mode is inactivated in step 411. When the proximity sensing mode is not inactivated, the controller 110 may return to step 403 and repeat the foregoing procedures. On the other hand, when the proximity sensing mode is inactivated, the controller 110 may terminate the proximity sensing function.

The following is an explanation of an exemplary proximity sensing method of a portable terminal 100 when a proximity sensing mode is activated according to activation of a call mode by way of example.

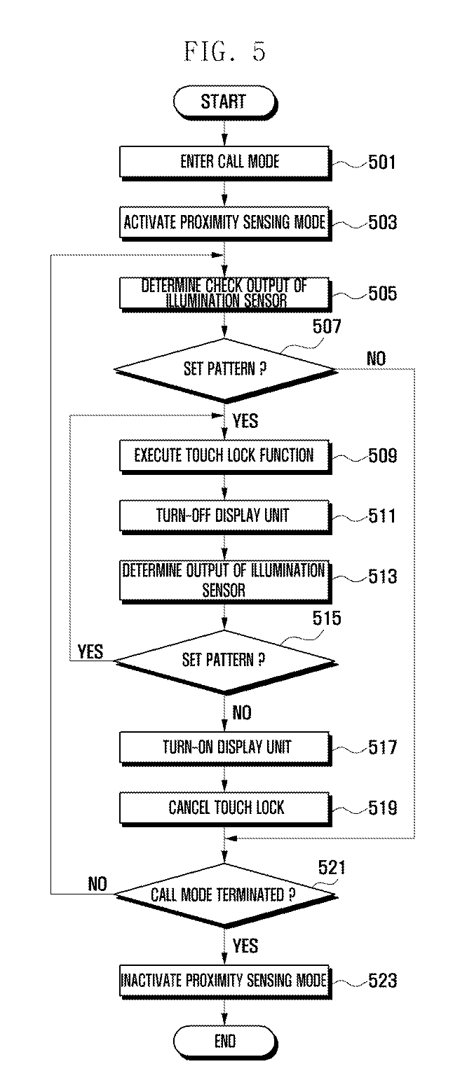

FIG. 5 is a flowchart schematically illustrating a proximity sensing method of a portable terminal 100 in a call mode according to an exemplary embodiment of the present invention.

Referring to FIG. 1 and FIG. 5, a controller 110 may enter a call mode in step 501. Upon transmission or reception of a call request, the controller 110 may enter the call mode. When the controller 110 enters the call mode, it may activate a proximity sensing mode in step 503. When the proximity sensing mode is activated, the controller 110 may determine an output of the illumination sensor 170 in step 505, and determine whether the output of the illumination sensor 170 has a set pattern in step 507. The set pattern may be a discrete pattern associated with a frame frequency set to drive the display unit 131.

If it is determined in step 507 that the output of the illumination sensor 170 does not have the set pattern, the controller 110 may go to step 521 which is described later. In this case, when a given time elapses in a state that proximity is not recognized, the display unit 131 may be turned-off. On the other hand, if it is determined in step 507 that the output of the illumination sensor 170 has the set pattern, namely, when the user moves the portable terminal 100 within a given distance from the user's face, the controller 110 may execute a touch lock function in step 509, and turn-off the display unit 131 in step 511. When the display unit 131 is completely turned-off, light from the display unit 131 is not input to the illumination sensor 170 and thus proximity cannot be recognized. To prevent the foregoing problem, the display unit 131 may not be completely turned-off but may emit light with minimum brightness that the illumination sensor 170 may recognize or the display unit 131 may be turned-off except for a partial area thereof. In an exemplary implementation, when the proximity is recognized, the controller 110 may completely turn-off the display unit 131 and maintain a proximity state until a light signal having a continuous pattern, namely natural light, is input. In the meantime, step 509 and step 511 may be simultaneously performed or an order thereof may be changed.

Subsequently, the controller 110 may determine an output of the illumination sensor 170 in step 513, and determine whether the output of the illumination sensor 170 has a set pattern in step 515. If it is determined in step 515 that the output of the illumination sensor 170 has the set pattern, the controller 110 may return to step 509. On the other hand, if it is determined in step 515 that the output of the illumination sensor 170 does not have the set pattern, namely, when the user spaces a called portable terminal 100 apart from the user's face by more than a given distance, the controller 110 may turn-on the display unit 131 in step 517 and cancel touch lock in step 519. In the meantime, step 517 and step 519 may be simultaneously performed or an order thereof may be changed.

Next, the controller 110 may determine whether a call mode is terminated in step 521. If it is determined in step 521 that the call mode is not terminated, the controller 110 may go to step 505 and repeat the foregoing procedures. On the other hand, if it is determined in step 521 that the call mode is terminated, the controller 110 may inactivate a proximity sensing mode and become an idle state in step 523.

As mentioned above, exemplary embodiments of the present invention may support a proximity sensing function using an illumination sensor instead of a proximity sensor to reduce a manufacturing cost of the portable terminal. In addition, since the present invention does not need a separate proximity sensor, a problem of a lack mounting space may be solved.

While the invention has been shown and described with reference to certain exemplary embodiments thereof, it will be understood by those skilled in the art will that various changes in form and details may be made therein without departing from the spirit and scope of the invention as defined in the appended claims and their equivalents.

What is claimed is:

1. A proximity sensing method of a portable terminal including an illumination sensor, the method comprising:
determining an output of the illumination sensor;
determining that the portable terminal is proximate to an object when the output of the illumination sensor has a preset pattern; and
determining that the portable terminal is not proximate to the object when the output of the illumination sensor does not have the preset pattern.

2. The method of claim 1, wherein the pattern comprises a discrete pattern associated with a frame frequency of a display unit.

3. The method of claim 2, further comprising:
activating a proximity sensing mode when the portable terminal enters a call mode; and
terminating the proximity sensing mode when the call mode is terminated.

4. The method of claim 3, further comprising executing a touch lock function when the proximity is sensed in the call mode.

5. The method of claim 4, further comprising canceling the touch lock function when the proximity is canceled in the call mode.

6. The method of claim 3, further comprising turning-off areas of the display unit except for a partial area of the display unit when the proximity is sensed in the call mode.

7. The method of claim 3, further comprising changing a brightness of the display unit to a minimum brightness that the illumination sensor can recognize when the proximity is sensed in the call mode.

8. The method of claim 6, further comprising turning-on the display unit when the proximity is canceled in the call mode.

9. The method of claim 3, further comprising turning-off the display unit when the proximity is sensed in the call mode.

10. A proximity sensing apparatus of a portable terminal, the apparatus comprising:
a display unit for displaying an image in response to a preset frame frequency;
an illumination sensor for outputting an electric signal in response to an input light; and
a controller for determining that the portable terminal is proximate to an object when the output of the illumination sensor has a preset pattern, and for determining that the portable terminal is not proximate to the object when the output of the illumination sensor does not have the preset pattern.

11. The apparatus of claim 10, wherein the controller comprises a voltage sensor for sensing the output of the illumination sensor.

12. The apparatus of claim 10, wherein the controller activates a proximity sensing mode when the portable terminal enters a call mode, and inactivates the proximity sensing mode when the call mode is terminated.

13. The apparatus of claim 12, wherein the controller turns-off areas of the display unit except for a partial area of the display unit when the proximity is sensed in the call mode.

14. The apparatus of claim 12, wherein the controller changes a brightness of the display unit to minimum brightness that the illumination sensor can recognize when the proximity is sensed in the call mode.

15. The apparatus of claim 13, wherein the controller turns-on the display unit when the proximity is canceled in the call mode.

16. The apparatus of claim 10, further comprising a touch sensor for sensing a touch.

17. The apparatus of claim 16, wherein the controller executes a touch lock function when the proximity is sensed in a call mode.

18. The apparatus of claim 17, wherein the controller cancels the touch lock function when the proximity is canceled in the call mode.

19. The apparatus of claim 12, wherein the controller turns-off the display when the proximity is sensed in the call mode.
